(19) United States
(12) Patent Application Publication
(10) Pub. No.: US 2021/0031809 A1
(43) Pub. Date: Feb. 4, 2021

(54) GUIDANCE CONTROL DEVICE, GUIDANCE SYSTEM, GUIDANCE CONTROL PROGRAM

(71) Applicant: TOYOTA JIDOSHA KABUSHIKI KAISHA, Toyota-shi (JP)

(72) Inventors: Kohta TARAO, Nagoya-shi (JP); Hiroki AWANO, Nerima-ku (JP); Kuniaki JINNAI, Nagoya-shi (JP); Yoshihiro MAEKAWA, Toyota-shi (JP)

(73) Assignee: TOYOTA JIDOSHA KABUSHIKI KAISHA, Toyota-shi (JP)

(21) Appl. No.: 16/930,456

(22) Filed: Jul. 16, 2020

(30) Foreign Application Priority Data
Jul. 29, 2019 (JP) 2019-138983

(51) Int. Cl. B60W 60/00; B60W 50/14; B60W 40/04; B60W 30/165; H04W 4/40

(52) U.S. Cl. CPC B60W 60/0059; B60W 60/0051; B60W 60/0017; B60W 60/0061; B60W 2050/007; B60W 40/04; B60W 30/165; H04W 4/40; B60W 50/14

(57) ABSTRACT

A guidance control device includes an acquisition section configured to acquire travel states of a plurality of vehicles traveling on a road, a detection section configured to detect a situation in which, among the plurality of vehicles, a predetermined proportion or more are a plurality of autonomously driven vehicles traveling in a periphery of a manually driven vehicle, and a guidance section configured to recommend remote driving or autonomous driving to a driver of the manually driven vehicle in a case in which the predetermined proportion or more of the plurality of autonomously driven vehicles traveling in the periphery of the manually driven vehicle are detected by the detection section.

### CROSS-REFERENCE TO RELATED APPLICATION

This application is based upon and claims the benefit of priority of the prior Japanese Patent Application No. 2019-138983, filed on Jul. 29, 2019, the entire contents of which are incorporated herein by reference.

### FIELD

The embodiments discussed herein are related to a guidance control device, a guidance system, and a guidance control program.

Patent Document 1 (Japanese Patent Application Laid-Open (JP-A) No. 2018-101199) discloses a driving support device in which travel state data and the like is acquired from peripheral vehicles that are equipped with a communication function, and a travel state is detected for peripheral vehicles that are not equipped with the communication function. The travel states of vehicles not equipped with the communication function are detected in order to predict the travel states of other vehicles peripheral to a primary vehicle.

In the driving support device disclosed in Patent Document 1 (JP-A No. 2018-101199), advantageous effects including the ability to detect whether peripheral vehicles are being autonomously driven or manually driven are obtained as a result of predicting the travel states of the other vehicles peripheral to the primary vehicle. However, the driving support device of Patent Document 1 makes no disclosure relating to notification of a driver of a manually driven vehicle in cases in which numerous autonomously driven vehicles are traveling peripherally to the manually driven vehicle. There is accordingly room for improvement with regard to providing driving support to the driver of a manually driven vehicle.

### SUMMARY

In consideration of the above circumstances, an object of the present disclosure is to provide a guidance control device, a guidance system, and a guidance control program capable of recommending remote driving or autonomous driving to a driver of the manually driven vehicle in cases in which a predetermined proportion or more of autonomously driven vehicles are traveling peripherally to the manual driven vehicle.

A guidance control device according to a first aspect of the present disclosure includes an acquisition section configured to acquire travel states of a plurality of vehicles traveling on a road, a detection section configured to detect a situation in which, among the plurality of vehicles, a predetermined proportion or more are a plurality of autonomously driven vehicles traveling in a periphery of a manually driven vehicle, and a guidance section configured to recommend remote driving or autonomous driving to a driver of the manually driven vehicle in a case in which the predetermined proportion or more of the plurality of autonomously driven vehicles traveling in the periphery of the manually driven vehicle are detected by the detection section.

In the guidance control device according to the first aspect, the travel states of the plural vehicles traveling on the road are acquired by the acquisition section. The detection section is configured to detect the situation in which the plural autonomously driven vehicles traveling peripherally to the manually driven vehicle correspond to the predetermined proportion or more of the plural vehicles. For example, in cases in which the plural autonomously driven vehicles traveling peripherally to the manually driven vehicle correspond to the predetermined proportion or more, there is a possibility that the driver of the manually driven vehicle might feel nervous. In the guidance control device described above, in cases in which the detection section detects such travel of plural autonomously driven vehicles corresponding to the predetermined proportion or more, the guidance section recommends remote driving or autonomous driving to the driver of the manually driven vehicle. Switching from the manual driving to the remote driving or the autonomous driving is deferred to the decision of the driver of the manually driven vehicle, thereby enabling any nervousness felt by the driver of the manually driven vehicle to be dispelled.

A guidance control device according to a second aspect is the guidance control device of the first aspect, wherein the detection section detects a proportion of the plural vehicles traveling within a predetermined range in the periphery of the manually driven vehicle that are the autonomously driven vehicles.

In the guidance control device according to the second aspect, the detection section detects the proportion of the plural vehicles traveling within the predetermined range in the surroundings of the manually driven vehicle that are the autonomously driven vehicles. This enables the driver of the manually driven vehicle to be urged toward the remote driving or the autonomous driving in cases in which it is appropriate to do so.

A guidance control device according to a third aspect is the guidance control device of the first aspect, wherein the acquisition section acquires the travel states of the plural vehicles by communicating with the plural vehicles.

In the guidance control device according to the third aspect, the acquisition section acquires the travel states of the plural vehicles by communicating with the plural vehicles. There is accordingly no need to install a separate acquisition section on the road on which the plural vehicles are traveling in order to acquire the travel states of the plural vehicles.

A guidance control device according to a fourth aspect is the guidance control device of the first aspect, wherein a remote center, from which remote driving is performed, is notified of the existence of the manually driven vehicle when the guidance section recommends remote driving to the driver of the manually driven vehicle.

In the guidance control device according to the fourth aspect, the remote center from which the remote driving is performed is notified of the existence of the manually driven vehicle when the guidance section recommends remote driving to the driver of the manually driven vehicle. This enables a smooth switch from the manual driving to the remote driving.

A guidance control device according to a fifth aspect is the guidance control device of the first aspect, wherein the detection section is configured to detect a situation in which, among the plurality of vehicles, a predetermined proportion or more are manually driven vehicles traveling in a periphery of an autonomously driven vehicle, and the guidance section is configured to recommend manual driving to the autonomously driven vehicle in a case in which the predetermined proportion or more of the manually driven vehicles traveling in a periphery of the autonomously driven vehicle are detected by the detection section.

In the guidance control device according to the fifth aspect, the detection section detects the occurrence of a situation in which manually driven vehicles traveling peripherally to the autonomously driven vehicle correspond to the predetermined proportion or more of the plural vehicles. In cases in which the detection section has detected the situation in which the manually driven vehicles traveling peripherally to the autonomously driven vehicle correspond to the predetermined proportion or more of the plural vehicles, the guidance section recommends manual driving to the autonomously driven vehicle. A driver of the autonomously driven vehicle is thus able to decide whether to continue with autonomous driving or to switch to manual driving.

A guidance control device according to a sixth aspect is the guidance control device of the first aspect, wherein the autonomously driven vehicles include an unoccupied remotely driven vehicle.

In the guidance control device according to the sixth aspect, the autonomously driven vehicles include the unoccupied remotely driven vehicle. Accordingly, the driver of the manually driven vehicle can be urged toward the remote driving or the autonomous driving in cases in which the autonomously driven vehicles including the unoccupied remotely driven vehicle traveling peripherally to the manually driven vehicle correspond to the predetermined proportion or more.

A guidance system according to a seventh aspect includes the guidance control device of the first aspect, a switchover control section configured to switch the manually driven vehicle to a remotely driven vehicle when remote driving has been recommended to the driver of the manually driven vehicle by the guidance section that recommends remote driving, a remote center configured to transmit control information to perform remote driving at the remotely driven vehicle that has been switched to remote driving by the switchover control section, and a remote driving control section provided at the remotely driven vehicle and configured to execute remote driving based on the control information received from the remote center.

In the guidance system according to the seventh aspect, when remote driving has been recommended to the driver of the manually driven vehicle by the guidance section that recommends remote driving, the manually driven vehicle is switched by the switchover control section to become a remotely driven vehicle. The control information to perform the remote driving is transmitted from the remote center to the remotely driven vehicle that has been switched by the switchover control section. The remote driving control section provided to the remotely driven vehicle executes remote driving based on the control information received from the remote center. This enables smooth switching of the manually driven vehicle to become a remotely driven vehicle and execute the remote driving.

A guidance system according to an eighth aspect is the guidance system of the seventh aspect, wherein the switchover control section is provided at the guidance control device.

In the guidance system according to the eighth aspect, the switchover control section is provided at the guidance control device. The manually driven vehicle is switched by the switchover control section so as to become the remotely driven vehicle.

A guidance system according to a ninth aspect is the guidance system of the seventh aspect, wherein the switchover control section does not switch the manually driven vehicle to a remotely driven vehicle in a case in which communication between the manually driven vehicle and the remote center is unstable.

In the guidance system according to the ninth aspect, in cases in which the communication between the manually driven vehicle and the remote center is unstable, the switchover control section does not switch the manually driven vehicle to the remotely driven vehicle. This enables situations in which communication between the manually driven vehicle and the remote center is cut off during remote driving, thus rendering remote driving unavailable to be suppressed.

A guidance system according to a tenth aspect is the guidance system of the seventh aspect, wherein the remote driving control section causes the remotely driven vehicle, which has been switched to remote driving by the switchover control section, to travel by remote driving so as to follow a mother car configured by any of the plurality of autonomously driven vehicles.

In the guidance system according to the tenth aspect, the remote driving control section causes the remotely driven vehicle switched by the switchover control section to travel by remote driving so as to follow the mother car configured by any of the plural autonomously driven vehicles. This enables the remotely driven vehicle to travel smoothly.

A guidance control program according to an eleventh aspect causes a computer to execute processing, the processing including a step of acquiring travel states of a plurality of vehicles traveling on a road, a step of detecting a situation in which, among the plurality of vehicles, a predetermined proportion or more are a plurality of autonomously driven vehicles traveling in a periphery of a manually driven vehicle, and a step of recommending remote driving or autonomous driving to a driver of the manually driven vehicle in a case in which the predetermined proportion or more of the plurality of autonomously driven vehicles traveling in the periphery of the manually driven vehicle are detected.

A guidance control device according to a twelfth aspect includes memory, and a processor connected to the memory. The processor is configured to acquire travel states of a plurality of vehicles traveling on a road, and detect a situation in which, among the plurality of vehicles, a predetermined proportion or more are a plurality of autonomously driven vehicles traveling in a periphery of a manually driven vehicle, and recommend remote driving or autonomous driving to a driver of the manually driven vehicle in a case in which the predetermined proportion or more of the plurality of autonomously driven vehicles traveling in the periphery of the manually driven vehicle are detected.

A guidance control method according to a thirteenth aspect includes a process of acquiring travel states of a plurality of vehicles traveling on a road, a process of detecting a situation in which, among the plurality of vehicles, a predetermined proportion or more are a plurality of autonomously driven vehicles traveling in a periphery of a manually driven vehicle, and a process of recommending remote driving or autonomous driving to a driver of the manually driven vehicle in a case in which the predetermined proportion or more of the plurality of autonomously driven vehicles traveling in the periphery of the manually driven vehicle are detected.

The guidance control device according to the present disclosure is capable of recommending remote driving or autonomous driving to a driver of the manually driven vehicle in cases in which a predetermined proportion or more of autonomously driven vehicles are traveling peripherally to the manual driven vehicle.

### BRIEF DESCRIPTION OF DRAWINGS

Exemplary embodiments of the present disclosure will be explained based on the following figures, wherein:

FIG. 1 is a diagram illustrating schematic configuration of a guidance system according to a first exemplary embodiment;

FIG. 2 is a block diagram illustrating hardware configuration of equipment installed in a vehicle;

FIG. 3 is a block diagram illustrating an example of functional configuration of a vehicle;

FIG. 4 is a block diagram illustrating hardware configuration of a server device;

FIG. 5 is a block diagram illustrating an example of functional configuration of a server device;

FIG. 6 is a block diagram illustrating hardware configuration of a remote operation station;

FIG. 7 is a block diagram illustrating an example of functional configuration of a remote operation station;

FIG. 8 is a flowchart illustrating a flow of guidance processing by a server device;

FIG. 9 is a flowchart illustrating a flow of first guidance processing by a remote operation station;

FIG. 10 is a flowchart illustrating a flow of second guidance processing by a remote operation station;

FIG. 11 is a diagram illustrating a state controlled by a guidance system according to the first exemplary embodiment, and illustrates a state in which plural vehicles are traveling on a road as viewed looking down from above;

FIG. 12 is a diagram illustrating a state controlled by a guidance system according to a second exemplary embodiment, and illustrates a state in which plural vehicles are traveling on a road as viewed looking down from above;

FIG. 13 is a flowchart illustrating a flow of guidance processing by a server device of a guidance system according to a third exemplary embodiment; and

FIG. 14 is a flowchart illustrating a flow of guidance processing by a server device of a guidance system according to a fourth exemplary embodiment.

### DESCRIPTION OF EMBODIMENTS

Explanation follows regarding examples of exemplary embodiments of the present disclosure, with reference to the drawings. Note that identical or equivalent configuration elements and portions are allocated the same reference numerals in each of the drawings.

### First Exemplary Embodiment

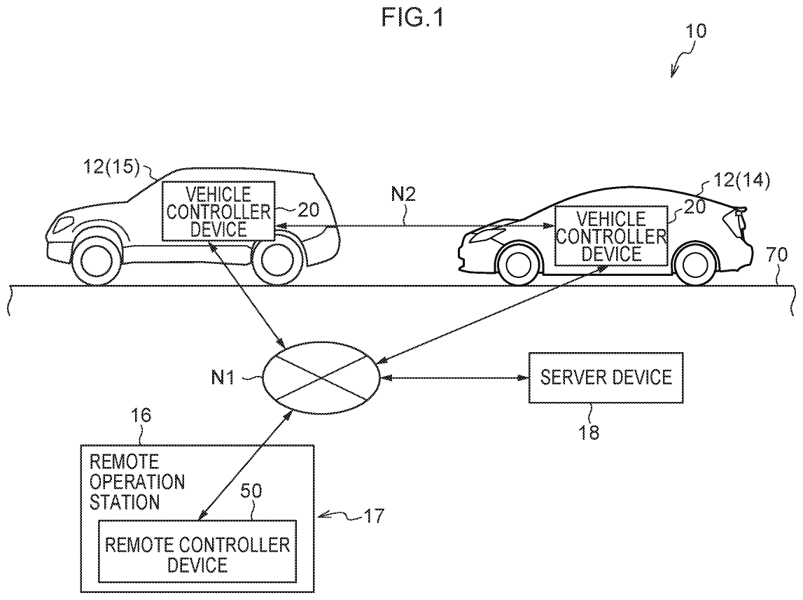

FIG. 1 is a diagram illustrating a schematic configuration of a guidance system according to a first exemplary embodiment.

As illustrated in FIG. 1, a guidance system 10 is configured including plural vehicles 12, a remote operation station 16 provided at a remote center 17, and a server device 18. The plural vehicles 12 include manually driven vehicles 14 traveling by manual driving, and autonomously driven vehicles 15 traveling by autonomous driving.

In the first exemplary embodiment, explanation will be given regarding an example in which the plural vehicles 12 are traveling along a road 70 in the same direction, as illustrated in FIG. 1. Although the manually driven vehicle 14 and the autonomously driven vehicle 15 are indicated by different reference numerals in FIG. 1, the manually driven vehicle 14 and the autonomously driven vehicle 15 are referred to collectively as the “vehicles 12” when no distinction is being made therebetween.

Each of the vehicles 12 includes a vehicle controller device 20. The remote operation station 16 includes a remote controller device 50. In the guidance system 10, the vehicle controller devices 20 of the vehicles 12 (including, for example, the manually driven vehicles 14 and the autonomously driven vehicles 15), the remote controller device 50 of the remote operation station 16, and the server device 18 are connected to one another through a network N1. The respective vehicle controller devices 20 are also capable of communicating directly with one another using vehicle-to-vehicle communication N2 (see FIG. 1). The server device 18 is an example of a guidance control device.

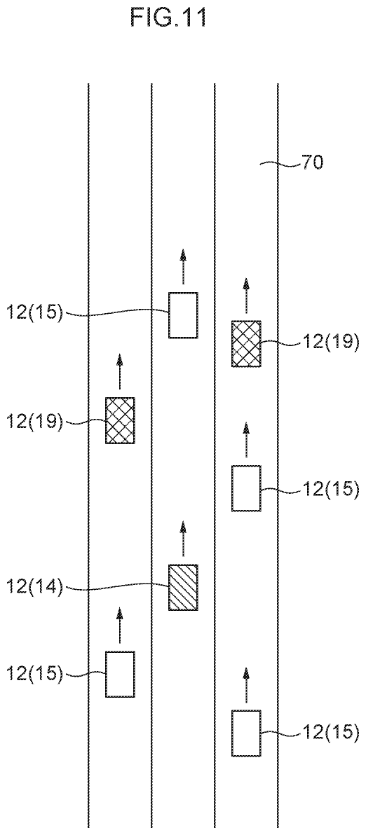

Although FIG. 1 only illustrates the manually driven vehicle 14 and the autonomously driven vehicle 15 traveling ahead of the manually driven vehicle 14, in reality the plural vehicles 12 traveling on the road 70 include a mix of manually driven vehicles 14, autonomously driven vehicles 15, and remotely driven vehicles 19 traveling by remote driving (see FIG. 11). Although the guidance system 10 illustrated in FIG. 1 is configured with a single remote operation station 16 and a single server device 18, the guidance system 10 may include two or more of both the remote operation stations 16 and the server devices 18.

Each of the vehicles 12 is capable of executing autonomous driving in which independent travel is executed based on a travel plan generated by their vehicle controller device 20, remote driving (namely remote-controlled driving) based on operation by a remote driver (namely, a remote-controlled driving operator) at the remote operation station 16, and manual driving based on operation by an occupant of the vehicle 12 (namely, a driver).

### Vehicles

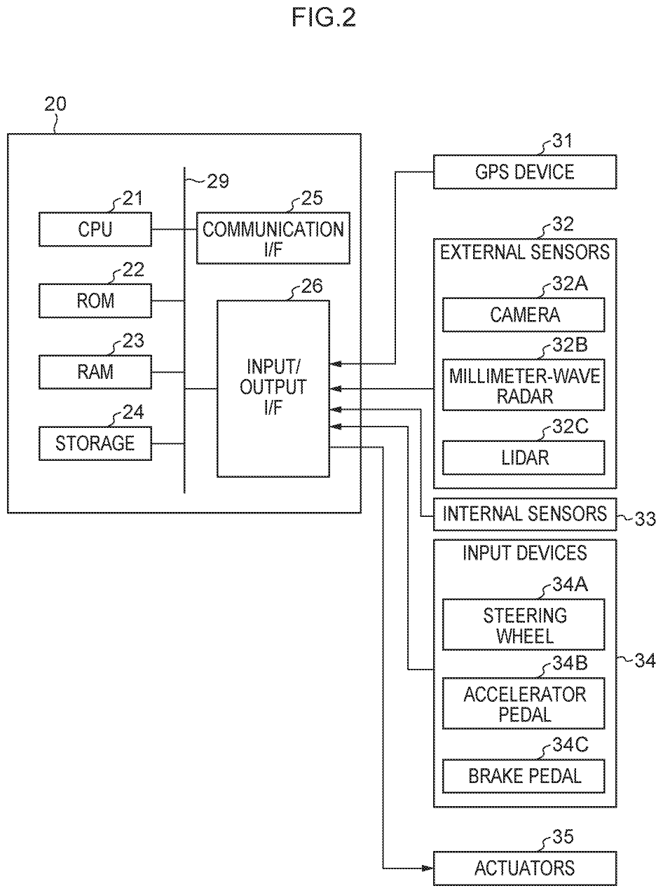

FIG. 2 is a block diagram illustrating hardware configuration of equipment installed in each of the vehicles 12. Note that although the manually driven vehicles 14 and the autonomously driven vehicles 15 configuring the vehicles 12 are configured similarly to each other in the first exemplary embodiment, the autonomously driven vehicles 15 may have a different configuration. As illustrated in FIG. 2, in addition to the vehicle controller device 20 mentioned above, each of the vehicles 12 includes a global positioning system (GPS) device 31, external sensors 32, internal sensors 33, input devices 34, and actuators 35.

The vehicle controller device 20 includes a central processing unit (CPU; a processor) 21, read only memory (ROM) 22, random access memory (RAM) 23, storage 24, a communication interface (I/F) 25, and an input/output I/F 26. The CPU 21, the ROM 22, the RAM 23, the storage 24, the communication I/F 25, and the input/output I/F 26 are connected together so as to be capable of communicating with each other through a bus 29.

The CPU 21 is a central processing unit that executes various programs and controls various sections. The CPU 21 reads a program from the ROM 22 or the storage 24 and executes the program, using the RAM 23 as a workspace. The CPU 21 controls the various configurations and performs various arithmetic processing based on the program recorded in the ROM 22 or the storage 24. In the first exemplary embodiment, a guidance program is held in the ROM 22 or the storage 24.

The ROM 22 holds various programs and various data. The RAM 23 serves as a workspace to temporarily store the programs or data.

The storage 24 is configured by a hard disk drive (HDD) or a solid state drive (SSD), and stores various programs including an operating system, as well as various data.

The communication I/F 25 includes an interface to connect to the network N1 in order to communicate with the other vehicle controller devices 20, the remote controller device 50, the server device 18, and so on. A communication protocol such as LTE or Wi-Fi (registered trademark in Japan) is employed for this interface. The communication I/F 25 also includes a wireless device to communicate directly with the other vehicle controller devices 20 using the vehicle-to-vehicle communication N2 that employs dedicated short range communications (DSRC) or the like.

The communication I/F 25 acquires travel information and the like relating to other vehicles 12 in the surroundings of the vehicle 12 to which the communication I/F 25 is installed through the vehicle-to-vehicle communication N2. The travel information includes a travel direction and travel speed of each of the other vehicles 12, the distance to each of the other vehicles 12, and the like.

The input/output I/F 26 is an interface for communicating with the various devices installed in the vehicle 12. In the vehicle controller device 20, the GPS device 31, the external sensors 32, the internal sensors 33, the input devices 34, and the actuators 35 are connected through the input/output I/F 26. Note that the GPS device 31, the external sensors 32, the internal sensors 33, the input devices 34, and the actuators 35 may be directly connected to the bus 29.

The GPS device 31 is a device for measuring the current position of the vehicle 12. The GPS device 31 includes an antenna (not illustrated in the drawings) to receive signals from GPS satellites.

The external sensors 32 are a group of sensors that detect peripheral information peripheral to the vehicle 12. The external sensors 32 include a camera 32A that captures a predetermined range, millimeter-wave radar 32B that transmits scanning waves over a predetermined range and picks up reflected waves, and laser imaging detection and ranging (LIDAR) 32C that scans a predetermined range. Note that plural of the cameras 32A may be provided. In such cases, a first camera 32A may image forward from the vehicle 12 while a second camera 32A images rearward from the vehicle 12. Configuration may be made in which one of the plural cameras 32A is a visible light camera and another of the plural cameras 32A is an infrared camera.

The internal sensors 33 are a group of sensors that detect travel states of the vehicle 12. The internal sensors 33 include at least one out of a vehicle speed sensor, an acceleration sensor, and a yaw rate sensor.

The input devices 34 are a group of switches to be operated by an occupant on board the vehicle 12. The input devices 34 include a steering wheel 34A serving as a switch to steer the steered wheels of the vehicle 12, an accelerator pedal 34B serving as a switch to cause the vehicle 12 to accelerate, and a brake pedal 34C serving as a switch to cause the vehicle 12 to decelerate.

The actuators 35 include a steering wheel actuator to drive the steered wheels of the vehicle 12, an accelerator actuator to control acceleration of the vehicle 12, and a brake actuator to control deceleration of the vehicle 12.

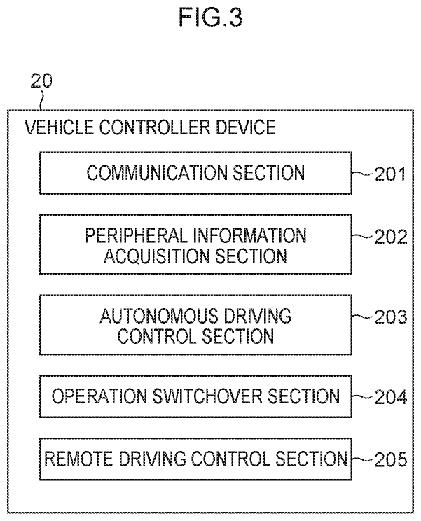

FIG. 3 is a block diagram illustrating an example of functional configuration of the vehicle controller device 20.

As illustrated in FIG. 3, the vehicle controller device 20 includes a communication section 201, a peripheral information acquisition section 202, an autonomous driving control section 203, an operation switchover section 204, and a remote driving control section 205. The communication section 201, the peripheral information acquisition section 202, the autonomous driving control section 203, the operation switchover section 204, and the remote driving control section 205 are implemented by the CPU 21 reading and executing the guidance program stored in the ROM 22 or the storage 24.

The communication section 201 communicates with the other vehicles 12, communicates with the server device 18, and also communicates with the remote operation station 16.

The peripheral information acquisition section 202 acquires peripheral information from the periphery of the vehicle 12. The peripheral information acquisition section 202 acquires the peripheral information from the periphery of the vehicle 12 from the external sensors 32 through the input/output I/F 26. The peripheral information acquisition section 202 also receives the peripheral information from the periphery of the vehicle 12 through the vehicle-to-vehicle communication N2. The peripheral information includes not only other vehicles 12 traveling peripherally to the vehicle 12, pedestrians, and the like, but also information relating to the weather, brightness, road width, obstacles, and the like. The peripheral information also includes information such as the travel direction and travel speed of each of the other vehicles 12 traveling periphery to the vehicle 12 and the distances between the plural vehicles 12.

The autonomous driving control section 203 creates a travel plan and controls autonomous driving of the vehicle 12 when traveling independently based on this travel plan. The autonomous driving control section 203 controls the autonomous driving of the vehicle 12 based on the peripheral information acquired by the peripheral information acquisition section 202, the position information of the vehicle 12 acquired by the GPS device 31, the travel information of the vehicle 12 acquired by the internal sensors 33, and the like. For example, the autonomously driven vehicle 15 illustrated in FIG. 1 acquires travel information from the vehicles 12 (including other vehicles 12 ahead of the autonomously driven vehicle 15 illustrated in FIG. 11, for example) in the surroundings of the autonomously driven vehicle 15 through the vehicle-to-vehicle communication N2. The autonomous driving control section 203 controls acceleration, deceleration, and steering of the autonomously driven vehicle 15 based on this information. The travel information includes, for example, information relating to the travel directions and travel speeds of the other vehicles 12, and the distances of the other vehicles 12.

The operation switchover section 204 switches to any driving mode out of manual driving, autonomous driving, and remote driving based on input signals relating to the driving mode. Driving mode switching by the operation switchover section 204 includes cases in which switching is performed in response to an occupant of the vehicle 12 inputting (for example when choosing) a driving mode, as well as cases in which switching to remote driving is performed based on a switchover signal from the remote operation station 16.

The remote driving control section 205 executes remote driving of the vehicle 12 based on control information for remote driving received from the remote operation station 16. In the first exemplary embodiment, control information for remote driving is transmitted to a vehicle 12 performing remote driving (see the remotely driven vehicle 19 illustrated in FIG. 11) from the remote operation station 16 such that the vehicle 12 executes remote driving.

### Server Device

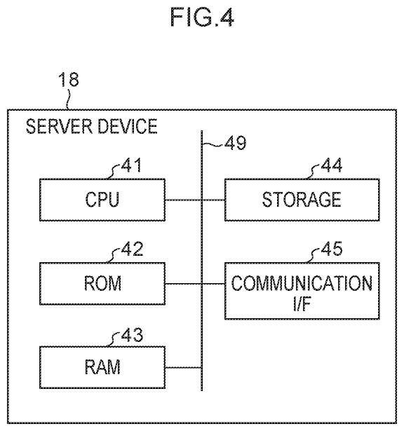

FIG. 4 is a block diagram illustrating hardware configuration of equipment installed in the server device 18.

As illustrated in FIG. 4, the server device 18 is configured including a CPU 41, ROM 42, RAM 43, storage 44, and a communication I/F 45. The CPU 41, the ROM 42, the RAM 43, the storage 44, and the communication I/F 45 are connected together so as to be capable of communicating with each other through a bus 49.

The CPU 41 is a central processing unit that executes various programs and controls various sections. The CPU 41 reads a program from the ROM 42 or the storage 44 and executes the program, using the RAM 43 as a workspace. The CPU 41 controls the various configurations and performs various arithmetic processing based on the program recorded in the ROM 42 or the storage 44. In the first exemplary embodiment, a guidance program is held in the ROM 42 or the storage 44.

The ROM 42 holds various programs and various data. The RAM 43 serves as a workspace to temporarily store the programs or data.

The storage 44 is configured by a hard disk drive (HDD) or a solid state drive (SSD), and stores various programs including an operating system, as well as various data.

The communication I/F 45 includes an interface to connect to the network N1 in order to communicate with the plural vehicle controller devices 20, the remote controller device 50, and so on. A communication protocol such as LTE or Wi-Fi (registered trademark in Japan) is employed for this interface.

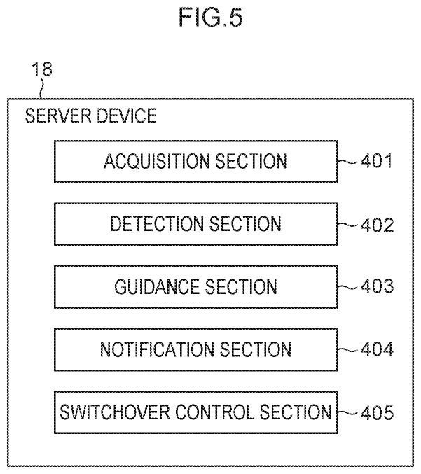

FIG. 5 is a block diagram illustrating an example of functional configuration of the server device 18.

As illustrated in FIG. 5, the server device 18 includes an acquisition section 401, a detection section 402, a guidance section 403, a notification section 404, and a switchover control section 405. The acquisition section 401, the detection section 402, the guidance section 403, the notification section 404, and the switchover control section 405 are implemented by the CPU 41 reading and executing the guidance program stored in the ROM 42 or the storage 44.

The acquisition section 401 acquires travel states of the plural vehicles 12 traveling on the road 70. The acquisition section 401 acquires the travel states of the plural vehicles 12 by communicating with the plural vehicles 12 over the network N1. The acquisition section 401 acquires information indicating whether each vehicle 12 is a manually driven vehicle 14, an autonomously driven vehicle 15, or a remotely driven vehicle 19 according to the travel states of the plural vehicles 12.

The detection section 402 detects the occurrence of a situation as acquired by the acquisition section 401 in which plural autonomously driven vehicles 15 traveling peripherally to the manually driven vehicle 14 (see FIG. 1 and FIG. 11) correspond to a predetermined proportion or greater of the plural vehicles 12. In the first exemplary embodiment, the detection section 402 detects the proportion of the plural vehicles 12 traveling within a predetermined range in the surroundings of the manually driven vehicle 14 that are autonomously driven vehicles 15.

The guidance section 403 urges the driver of the manually driven vehicle 14 toward remote driving in cases in which the detection section 402 has detected that the plural autonomously driven vehicles 15 traveling peripherally to the manually driven vehicle 14 correspond to the predetermined proportion or greater. For example, the guidance section 403 may be recommended remote driving to the driver of the manually driven vehicle 14.

The notification section 404 notifies the remote operation stations 16 at the remote center 17, from which remote driving is performed, of the existence of the manually driven vehicle 14 when the guidance section 403 advocates remote driving to the driver of the manually driven vehicle 14.

The switchover control section 405 controls switching of the vehicle 12 to remote driving. The switchover control section 405 outputs a switchover signal to the vehicle controller device 20 of the vehicle 12 to switch from autonomous driving or manual driving to remote-controlled driving. In the first exemplary embodiment, after the driver of the manually driven vehicle 14 has been urged toward remote driving by the guidance section 403, control is performed to switch the manually driven vehicle 14 to become a remotely driven vehicle 19 driven by remote driving.

### Remote Operation Station

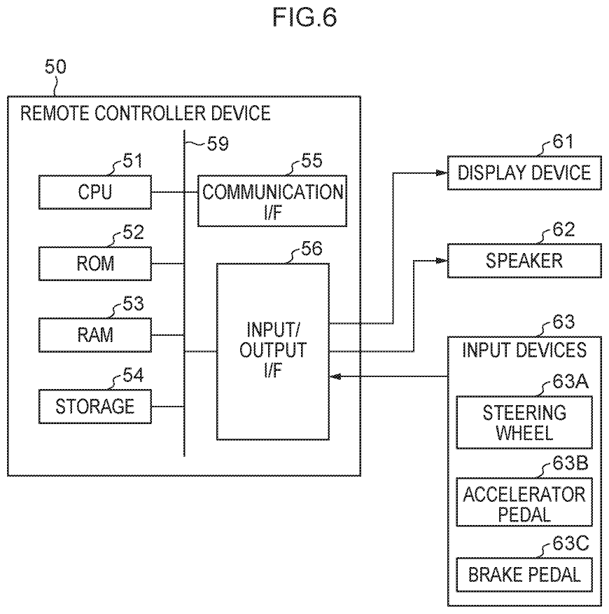

FIG. 6 is a block diagram illustrating hardware configuration of equipment installed in the remote operation station 16. In addition to the remote controller device 50 mentioned above, the remote operation station 16 also includes a display device 61, a speaker 62, and input devices 63.

The remote controller device 50 is configured including a CPU 51, ROM 52, RAM 53, storage 54, a communication I/F 55, and an input/output I/F 56. The CPU 51, the ROM 52, the RAM 53, the storage 54, the communication I/F 55, and the input/output I/F 56 are connected together so as to be capable of communicating with each other through a bus 59. Functionality of the CPU 51, the ROM 52, the RAM 53, the storage 54, the communication I/F 55, and the input/output I/F 56 matches that of the CPU 21, the ROM 22, the RAM 23, the storage 24, the communication I/F 25, and the input/output I/F 26 of the vehicle controller device 20 previously described.

The CPU 51 reads a program from the ROM 52 or the storage 54, and executes the program, using the RAM 53 as a workspace. In the first exemplary embodiment, a guidance program is stored in the ROM 52.

The display device 61, the speaker 62, and the input devices 63 are connected to the remote controller device 50 of the first exemplary embodiment through the input/output I/F 56. Note that the display device 61, the speaker 62, and the input devices 63 may be directly connected to the bus 59.

The display device 61 is a liquid crystal monitor for displaying an image captured by the camera 32A of a corresponding vehicle 12 and various information relating to the vehicle 12.

The speaker 62 is a speaker for replaying audio recorded by a microphone (not illustrated in the drawings) attached to the camera 32A of the vehicle 12 together with the captured image.

The input devices 63 are controllers to be operated by a remote driver (namely, a remote-controlled driving operator) using the remote operation station 16. The input devices 63 include a steering wheel 63A serving as a switch to steer the steered wheels of the vehicle 12 (for example the remotely driven vehicle 19 in the first exemplary embodiment), an accelerator pedal 63B serving as a switch to cause the vehicle 12 to accelerate, and a brake pedal 63C serving as a switch to cause the vehicle 12 to decelerate. Note that the modes of the respective input devices 63 are not limited thereto. For example, a lever switch may be provided instead of the steering wheel 63A. As another example, push button switches or lever switches may be provided instead of the pedal switches of the accelerator pedal 63B and the brake pedal 63C.

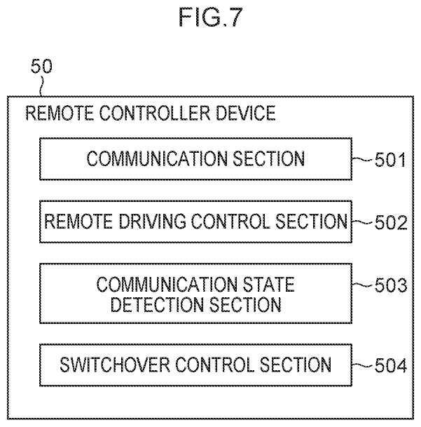

FIG. 7 is a block diagram illustrating an example of functional configuration of the remote controller device 50.

As illustrated in FIG. 7, the remote controller device 50 includes a communication section 501, a remote driving control section 502, a communication state detection section 503, and a switchover control section 504.

The communication section 501 communicates with a vehicle 12 employing remote driving (the remotely driven vehicle 19 in the first exemplary embodiment) and also communicates with the server device 18. The communication section 501 receives captured images and audio from the camera 32A, as well as vehicle information such as the vehicle speed, transmitted from the vehicle controller device 20. The received captured images and vehicle information are displayed on the display device 61, and the audio information is output through the speaker 62.

When remote-controlled driving is being performed based on operation by a remote driver, the remote driving control section 502 controls remote driving of the vehicle 12 (the remotely driven vehicle 19 in the first exemplary embodiment) based on signals input from the various input devices 63 by transmitting control information to perform remote driving to the vehicle controller device 20 through the communication section 501. For example, the remote driving control section 502 may set any one of the plural autonomously driven vehicles 15 traveling ahead of the remotely driven vehicle 19 as a mother car, and cause the remotely driven vehicle 19 to travel by remote driving so as to follow behind the mother car.

The communication state detection section 503 detects a communication state between the vehicle 12 employing remote driving and the remote operation station 16. As the communication states, the communication state detection section 503 detects whether communication between the vehicle 12 and the remote operation station 16 is stable or whether communication between the vehicle 12 and the remote operation station 16 is unstable.

The switchover control section 504 controls switching of the vehicle 12 to remote driving. The switchover control section 504 outputs a switchover signal to the vehicle controller device 20 of the corresponding vehicle 12 in order to switch the vehicle 12 from autonomous driving or manual driving to remote-controlled driving. For example, in cases in which the communication state detected by the communication state detection section 503 is stable, the switchover control section 504 performs control to switch a manually driven vehicle 14 to become a remotely driven vehicle 19 that is remotely driven. In other words, the switchover control section 504 does not switch a manually driven vehicle 14 to remote driving in cases in which the communication state detected by the communication state detection section 503 is unstable.

### Control Flow

Explanation follows regarding operation of the guidance system 10. Note that in the first exemplary embodiment, operation of the server device 18 will be explained first, followed by explanation regarding operation of the remote controller device 50.

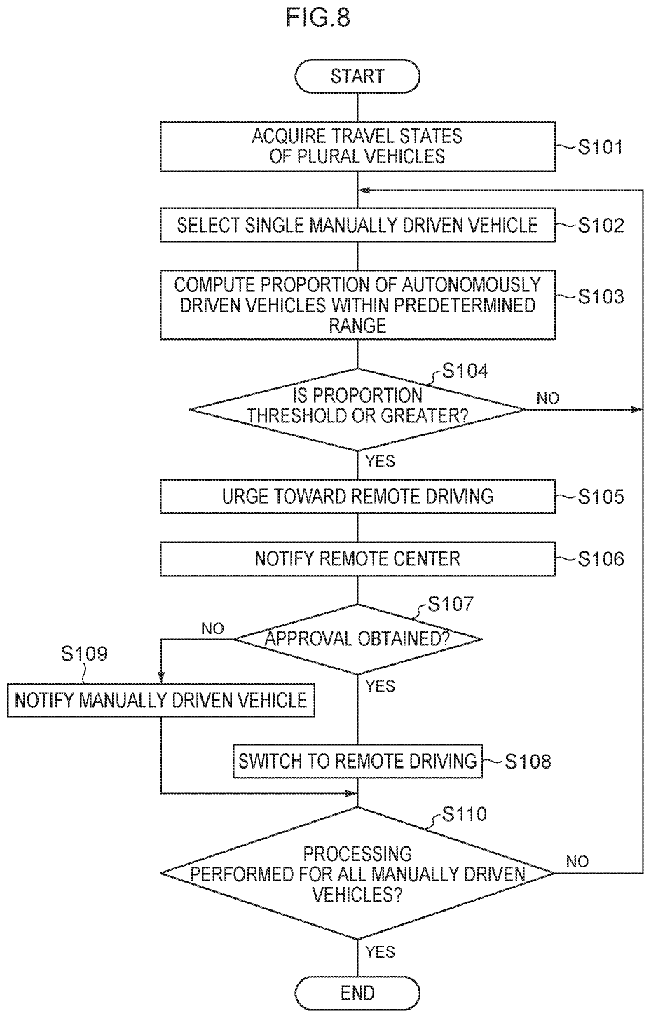

FIG. 8 is a flowchart illustrating a flow of guidance processing by equipment installed in the server device 18. The CPU 41 reads the guidance program from the ROM 42 or the storage 44, expands the guidance program in the RAM 43, and executes the guidance program in order to perform the guidance processing.

At step S101, the CPU 41 acquires the travel states of the plural vehicles 12. As illustrated in FIG. 11, in cases in which plural of the vehicles 12 are traveling on the road 70, the CPU 41 receives the travel states of each of the plural vehicles 12. The travel states of the plural vehicles 12 are acquired in order to acquire information as to whether each of the vehicles 12 is a manually driven vehicle 14, an autonomously driven vehicle 15, or a remotely driven vehicle 19.

At step S102, the CPU 41 selects a single manually driven vehicle 14 based on the travel states of the plural vehicles 12.

At step S103, the CPU 41 computes the proportion of the plural vehicles 12 traveling within a predetermined range in the surroundings of the single selected manually driven vehicle 14 that are autonomously driven vehicles 15. The predetermined range is, for example, set as a circular range with a radius of 200 m, 400 m, 600 m, 800 m, or 1000 m centered on the single selected manually driven vehicle 14. For example, the driver of the manually driven vehicle 14 may feel nervous if there is a high proportion of autonomously driven vehicles 15 traveling peripherally to the manually driven vehicle 14. The predetermined range is set in advance as a range in which such nervousness of the driver of the manually driven vehicle 14 can be dispelled by switching the manually driven vehicle 14 to become a remotely driven vehicle 19.

At step S104, the CPU 41 determines whether or not the proportion of the plural vehicles 12 that are autonomously driven vehicles 15 is a threshold value or higher. The threshold is, for example, set to a numerical value such as 40%, 50%, 60%, or 70%. The threshold is set in advance as a numerical value enabling nervousness of the driver of the manually driven vehicle 14 to be dispelled by switching the manually driven vehicle 14 to become a remotely driven vehicle 19.

In cases in which the proportion of the plural vehicles 12 that are autonomously driven vehicles 15 is below the threshold (namely, when step S104: NO), the CPU 41 returns to the processing of step S102.

In cases in which the proportion of the plural vehicles 12 that are autonomously driven vehicles 15 is the threshold or greater (namely, when step S104: YES), at step S105 the CPU 41 urges the driver of the single selected manually driven vehicle 14 toward remote driving. The manually driven vehicle 14 is guided toward remote driving by the server device 18 through the network N1.

At step S106, the CPU 41 notifies the remote operation station 16 at the remote center 17 that the manually driven vehicle 14 is being guided toward remote driving.

At step S107, the CPU 41 determines whether or not the remote operation station 16 at the remote center 17 has approved to remote driving.

In cases in which remote driving has been approved (namely, when step S107: YES), at step S108 the CPU 41 switches the single selected manually driven vehicle 14 to remote driving. In this manner, as illustrated in FIG. 11, the manually driven vehicle 14 is switched to remote driving in cases in which the proportion of the plural vehicles 12 traveling within the predetermined range in the surroundings of the manually driven vehicle 14 that are autonomously driven vehicles 15 is the threshold or greater.

In cases in which the remote operation station 16 does not approve remote driving (namely, when step S107: NO), at step S109 the CPU 41 notifies the single selected manually driven vehicle 14 that approval for remote driving cannot be obtained.

Following the processing of either step S108 or step S109, at step S110 the CPU 41 determines whether or not the processing has been performed for all of the manually driven vehicles 14. More specifically, the CPU 41 determines whether or not the processing has been performed for all of the manually driven vehicles 14 out of the plural vehicles 12 for which the travel state was acquired at step S101.

In cases in which processing has not been performed for all of the manually driven vehicles 14 (namely, when step S110: NO), the CPU 41 returns to the processing of step S102.

In cases in which processing has been performed for all of the manually driven vehicles 14 (namely, when step S110: YES), the CPU 41 ends the processing based on the guidance program.

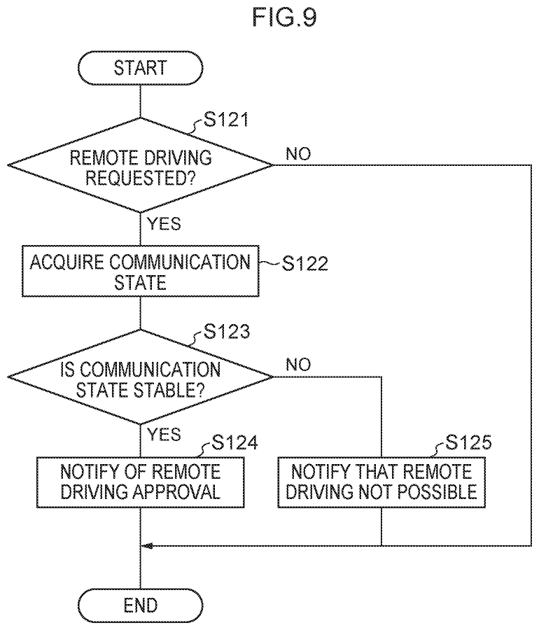

FIG. 9 is a flowchart illustrating a flow of first guidance processing by equipment installed in the remote controller device 50. The CPU 51 reads the guidance program from the ROM 52 or the storage 54, expands the guidance program in the RAM 53, and executes the guidance program in order to perform the first guidance processing. In the first exemplary embodiment, the guidance processing illustrated in FIG. 9 is executed in cases in which the remote operation station 16 has been notified at step S106 in FIG. 8 that the manually driven vehicle 14 is being guided toward remote driving.

At step S121, the CPU 51 determines whether or not a remote driving request for a manually driven vehicle 14 has been made by the server device 18.

In cases in which a remote driving request has been made (namely, when step S121: YES), at step S122 the CPU 51 acquires a communication state between the manually driven vehicle 14 and the remote controller device 50.

In cases in which a remote driving request has not been made (namely, when step S121: NO), the CPU 51 ends the processing based on the guidance program.

At step S123, the CPU 51 determines whether or not the communication state between the manually driven vehicle 14 and the remote controller device 50 is stable.

In cases in which the communication state is stable (namely, when step S123: YES), at step S124 the CPU 51 notifies the server device 18 of its approval for remote driving.

In cases in which the communication state is not stable (namely, when step S123: NO), at step S125 the CPU 51 notifies the server device 18 that remote driving is not possible.

Following the processing of either step S124 or step S125, the CPU 51 ends the first guidance processing based on the guidance program. The server device 18 then performs the processing of step S107 illustrated in FIG. 8 following the first guidance processing illustrated in FIG. 9.

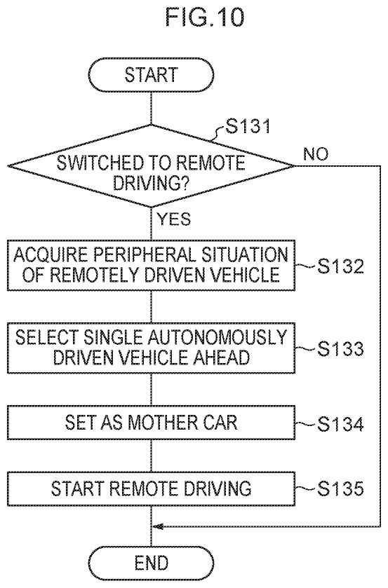

FIG. 10 is a flowchart illustrating a flow of second guidance processing by equipment installed in the remote controller device 50. The CPU 51 reads the guidance program from the ROM 52 or the storage 54, expands the guidance program in the RAM 53, and executes the guidance program in order to perform the second guidance processing. In the first exemplary embodiment, the second guidance processing is executed after the guidance processing illustrated in FIG. 8 performed by the server device 18.

At step S131, the CPU 51 determines whether or not the manually driven vehicle 14 has been switched to remote driving.

In cases in which the switch to remote driving has been performed (namely, when step S131: YES), at step S132 the CPU 51 acquires a peripheral situation peripheral to the vehicle 12 that has been switched to remote driving (namely, the remotely driven vehicle 19 that has been switched from manual driving to remote driving). In cases in which the manually driven vehicle 14 has not been switched to remote driving (namely, when step S131: NO), the CPU 51 ends the processing based on the guidance program.

At step S133, the CPU 51 selects a single autonomously driven vehicle 15 that is ahead of the vehicle 12 that has been switched to remote driving (namely, the remotely driven vehicle 19 that has been switched from manual driving to remote driving) from the peripheral situation at the periphery of the vehicle 12.

At step S134, the CPU 51 sets the autonomously driven vehicle 15 selected at step S133 as a mother car. Here, the mother car refers to a vehicle that leads the way during travel, namely a vehicle 12 utilized in travel by the other vehicle 12 traveling behind.

At step S135, the CPU 51 starts remote driving of the vehicle 12 that has been switched to remote driving. In the first exemplary embodiment, the vehicle 12 that has been switched to remote driving (namely, the remotely driven vehicle 19 that has been switched from manual driving to remote driving) travels by remote driving so as to follow behind the mother car set at step S134. After the processing of step S135, the CPU 51 ends the processing based on the guidance program.

Generally, in cases in which plural autonomously driven vehicles traveling within the predetermined range peripheral to a manually driven vehicle correspond to the predetermined proportion or greater, there is a possibility that the driver of the manually driven vehicle might feel nervous.

As illustrated in FIG. 11, in the guidance system 10 described above, when a situation is detected in which plural autonomously driven vehicles 15 corresponding to the predetermined proportion or greater are traveling within the predetermined range peripheral to the manually driven vehicle 14, the server device 18 urges the driver of the manually driven vehicle 14 toward remote driving. By switching the manually driven vehicle 14 from manual driving to remote driving, any nervousness felt by the driver of the manually driven vehicle 14 can be dispelled.

Moreover, in the guidance system 10, in cases in which the communication between the manually driven vehicle 14 and the remote controller device 50 at the remote center 17 is unstable, the manually driven vehicle 14 is not switched to become a remotely driven vehicle. This enables situations in which communication between the manually driven vehicle 14 and the remote center 17 is cut off during remote driving, thus rendering remote driving unavailable to be suppressed.

In the guidance system 10, the vehicle 12 that has been switched to remote driving travels by remote driving so as to follow the mother car configured by one out of the plural autonomously driven vehicles 15. This thereby enables the vehicle 12 to travel smoothly after switching to remote driving.

### Second Exemplary Embodiment

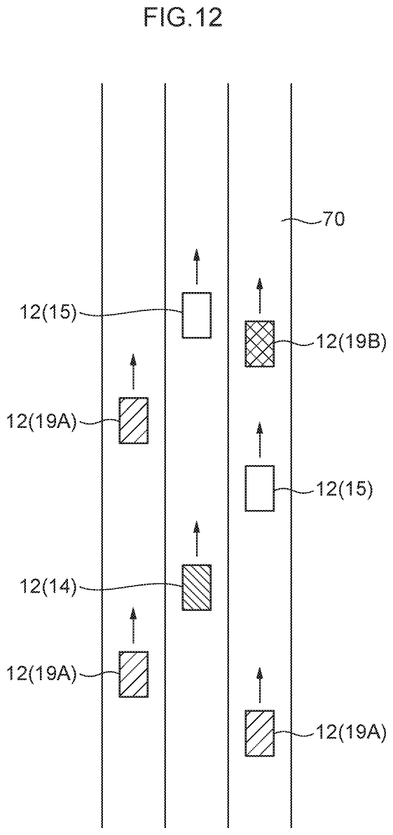

FIG. 12 is a diagram corresponding to a guidance system according to a second exemplary embodiment, and illustrates a state in which plural vehicles are traveling on a road as viewed looking down from above. Note that configuration elements equivalent to those in the first exemplary embodiment described above are allocated the same reference numerals, and explanation thereof is omitted.

In the guidance system of the second exemplary embodiment, the acquisition section 401 of the server device 18 acquires travel states of the plural vehicles 12 traveling on the road 70 (see FIG. 12). The acquisition section 401 acquires information regarding whether each vehicle 12 is a manually driven vehicle 14, an autonomously driven vehicle 15, an unoccupied remotely driven vehicle 19A (namely, in which no occupant is on board), or an occupied remotely driven vehicle 19B (namely, in which an occupant is on board), based on the travel states of the plural vehicles 12.

The detection section 402 of the server device 18 detects occurrence of a situation in which plural autonomously driven vehicles 15 and unoccupied remotely driven vehicles 19A traveling within the predetermined range peripheral to a manually driven vehicle 14 correspond to a predetermined proportion or greater of the plural vehicles 12. In order to perform this detection, the detection section 402 computes the total proportion of the plural vehicles 12 that are the plural autonomously driven vehicles 15 or unoccupied remotely driven vehicles 19A.

The guidance section 403 of the server device 18 urges the driver of the manually driven vehicle 14 toward remote driving in cases in which the detection section 402 has detected that the plural autonomously driven vehicles 15 and unoccupied remotely driven vehicles 19A traveling within the predetermined range peripheral to the manually driven vehicle 14 correspond to the predetermined proportion or greater.

Other configurations and control of the guidance system of the second exemplary embodiment are the same as the configurations and control of the guidance system of the first exemplary embodiment.

The guidance system of the second exemplary embodiment enables the driver of the manually driven vehicle 14 to be urged toward remote driving in cases in which the plural autonomously driven vehicles 15 and unoccupied remotely driven vehicles 19A traveling within the predetermined range peripheral to the manually driven vehicle 14 correspond to the predetermined proportion or greater. In this manner, the manually driven vehicle 14 is switched from manual driving to remote driving, enabling any nervousness felt by the driver of the manually driven vehicle 14 to be even further dispelled.

### Third Exemplary Embodiment

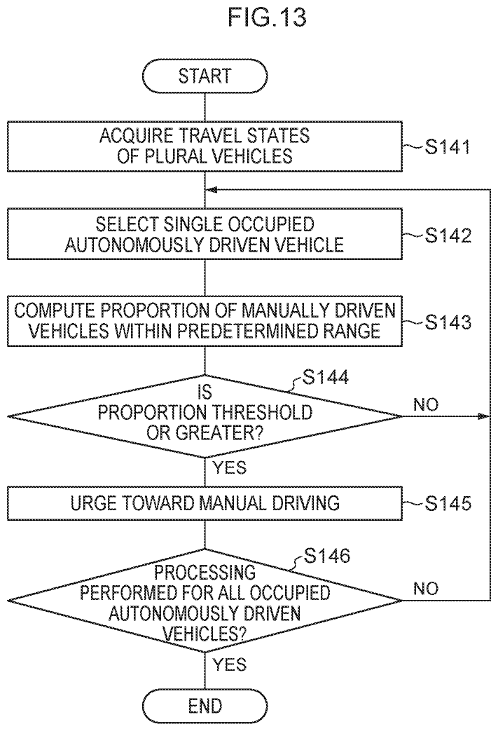

FIG. 13 is a flowchart illustrating a flow of guidance processing by a server device of a guidance system according to a third exemplary embodiment. Note that configuration elements equivalent to those in the first and second exemplary embodiments described above are allocated the same reference numerals, and explanation thereof is omitted.

In the guidance system according to the third exemplary embodiment, the server device 18 includes the following functionality in addition to the functionality of the server device 18 of the first exemplary embodiment. The detection section 402 is capable of detecting a situation in which manually driven vehicles 14 traveling peripherally to an autonomously driven vehicle 15 correspond to a predetermined proportion or greater of the plural vehicles 12. The guidance section 403 urges the autonomously driven vehicle 15 toward manual driving in cases in which the detection section 402 has detected that the manually driven vehicles 14 traveling peripherally to the autonomously driven vehicle 15 correspond to the predetermined proportion or greater of the plural vehicles 12. For example, the guidance section 403 may be recommended manual driving to the autonomously driven vehicle 15.

In the guidance system according to the third exemplary embodiment, in addition to guidance processing to urge a manually driven vehicle 14 toward remote driving as in the guidance system 10 according to the first exemplary embodiment, the server device 18 also performs the guidance processing illustrated in FIG. 13. The CPU 41 reads the guidance program from the ROM 42 of the storage 44, expands the guidance program in the RAM 43, and executes the guidance program in order to perform the guidance processing.

At step S141, the CPU 41 acquires the travel states of the plural vehicles 12 traveling on the road 70. The travel states of the plural vehicles 12 are acquired in order to acquire information as to whether each of the vehicles 12 is a manually driven vehicle 14, an autonomously driven vehicle 15 (information as to whether this is occupied or unoccupied is also acquired in the third exemplary embodiment), or a remotely driven vehicle 19.

At step S142, the CPU 41 selects a single occupied autonomously driven vehicle 15 based on the travel states of the plural vehicles 12.

At step S143, the CPU 41 computes the proportion of the plural vehicles 12 traveling in a predetermined range in the surroundings of the single selected autonomously driven vehicle 15 that are manually driven vehicles 14. The predetermined range is, for example, set as a circular range with a radius of 200 m, 400 m, 600 m, 800 m, or 1000 m centered on the single selected autonomously driven vehicle 15.

At step S144, the CPU 41 determines whether or not the proportion of the plural vehicles 12 that are manually driven vehicles 14 is a threshold or greater. The threshold is, for example, set to a numerical value such as 40%, 50%, 60%, or 70%.

In cases in which the proportion of the plural vehicles 12 that are manually driven vehicles 14 is below the threshold (namely, when step S144: NO), the CPU 41 returns to the processing of step S142.

In cases in which the proportion of the plural vehicles 12 that are manually driven vehicles 14 is the threshold or greater (namely, when step S144: YES), at step S145 the CPU 41 urges an occupant of the single selected autonomously driven vehicle 15 (a driver capable of manual driving in the third exemplary embodiment) toward manual driving. This guidance of the autonomously driven vehicle 15 toward manual driving by the server device 18 is conducted over the network N1. In the guidance system according to the third exemplary embodiment, whether or not to switch the autonomously driven vehicle 15 from autonomous driving to manual driving is deferred to the decision of the occupant (a driver capable of manual driving in the third exemplary embodiment) of the autonomously driven vehicle 15.

At step S146, the CPU 41 determines whether or not the processing has been performed for all occupied autonomously driven vehicles 15. More specifically, the CPU 41 determines whether or not the processing has been performed for all of the occupied autonomously driven vehicles 15 out of the plural vehicles 12 for which the travel state was acquired at step S141.

In cases in which processing has not been performed for all of the occupied autonomously driven vehicles 15 (namely, when step S146: NO), the CPU 41 returns to the processing of step S142.

In cases in which processing has been performed for all of the occupied autonomously driven vehicles 15 (namely, when step S146: YES), the CPU 41 ends the processing based on the guidance program.

In the guidance system according to the third exemplary embodiment, the autonomously driven vehicle 15 is urged toward manual driving in cases in which a situation has been detected in which the manually driven vehicles 14 traveling within the predetermined range peripheral to the autonomously driven vehicle 15 correspond to the predetermined proportion or greater of the plural vehicles 12. The driver of the autonomously driven vehicle 15 is thus able to decide whether to continue with autonomous driving or to switch to manual driving.

### Fourth Exemplary Embodiment

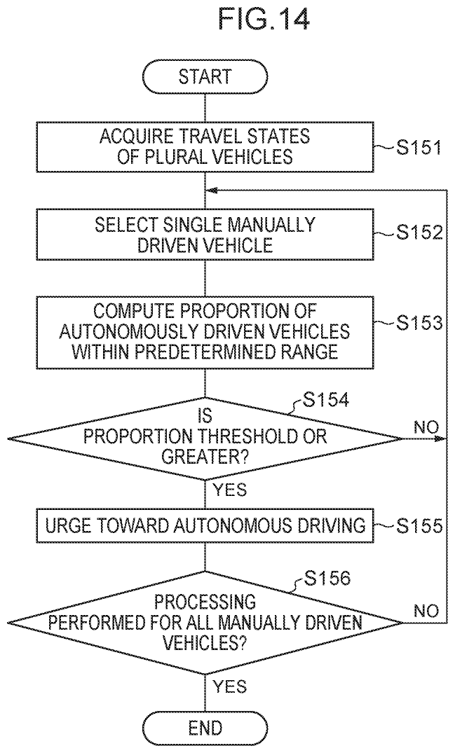

FIG. 14 is a flowchart illustrating a flow of guidance processing by a server device of a guidance system according to a fourth exemplary embodiment. Note that configuration elements equivalent to those in the first to third exemplary embodiments described above are allocated the same reference numerals, and explanation thereof is omitted.

In the guidance system according to the fourth exemplary embodiment, the server device 18 performs guidance processing as illustrated in FIG. 14 instead of the guidance processing by the server device 18 of the guidance system 10 according to the first exemplary embodiment. The CPU 41 reads a guidance program from the ROM 42 or the storage 44, expands the guidance program in the RAM 43, and executes the guidance program in order to perform the guidance processing.

At step S151, the CPU 41 acquires the travel states of the plural vehicles 12 traveling on the road 70. The travel states of the plural vehicles 12 are acquired in order to acquire information as to whether each of the vehicles 12 is a manually driven vehicle 14, an autonomously driven vehicle 15, or a remotely driven vehicle 19.

At step S152, the CPU 41 selects a single manually driven vehicle 14 based on the travel states of the plural vehicles 12.

At step S153, the CPU 41 computes the proportion of the plural vehicles 12 traveling within a predetermined range in the surroundings of the single selected manually driven vehicle 14 that are autonomously driven vehicles 15. The predetermined range is, for example, set as a circular range with a radius of 200 m, 400 m, 600 m, 800 m, or 1000 m centered on the single selected manually driven vehicle 14.

At step S154, the CPU 41 determines whether or not the proportion of the plural vehicles 12 that are autonomously driven vehicles 15 is a threshold or greater. The threshold is, for example, set to a numerical value such as 40%, 50%, 60%, or 70%.

In cases in which the proportion of the plural vehicles 12 that are autonomously driven vehicles 15 is below the threshold (namely, when step S154: NO), the CPU 41 returns to the processing of step S152.

In cases in which the proportion of the plural vehicles 12 that are autonomously driven vehicles 15 is the threshold or greater (namely, when step S154: YES), at step S155 the CPU 41 urges the driver of the single selected manually driven vehicle 14 toward autonomous driving. This guidance of the manually driven vehicle 14 toward autonomous driving by the server device 18 is conducted over the network N1. In the guidance system according to the fourth exemplary embodiment, whether or not to switch the manually driven vehicle 14 from manual driving to autonomous driving is deferred to the decision of the driver of the manually driven vehicle 14.

At step S156, the CPU 41 determines whether or not the processing has been performed for all of the manually driven vehicles 14.

In cases in which processing has not been performed for all of the manually driven vehicles 14 (namely, when step S156: NO), the CPU 41 returns to the processing of step S152.

In cases in which processing has been performed for all of the manually driven vehicle 14 (namely, when step S156: YES), the CPU 41 ends the processing based on the guidance program.

In the guidance system according to the fourth exemplary embodiment, the driver of the manually driven vehicle 14 is urged toward autonomous driving in cases in which a situation has been detected in which the plural autonomously driven vehicles 15 traveling within the predetermined range in the surroundings of the manually driven vehicle 14 correspond to the predetermined proportion or greater. The driver of the manually driven vehicle 14 is thus allowed to decide whether or not to switch from manual driving to autonomous driving, thereby enabling any nervousness felt by the driver of the manually driven vehicle 14 to be dispelled. In the guidance system according to the fourth exemplary embodiment, the CPU 41 may be recommended autonomous driving to the driver of the manually driven vehicle 14.

Explanation has been given regarding the guidance systems of the first to fourth exemplary embodiments. However, the present disclosure is not limited to the above exemplary embodiments. Various modifications or improvements thereto may be implemented.

In the guidance system of the first exemplary embodiment, a step may be provided between steps S106 and S107 in the flowchart of FIG. 8 to determine whether or not the consent of the driver of the manually driven vehicle 14 has been obtained. The switch to remote driving (see step S108) may then be performed in cases in which the consent of the driver of the manually driven vehicle 14 has been obtained.

In the guidance system of the fourth exemplary embodiment, a step may be provided between steps S154 and S155 in the flowchart of FIG. 14 to determine whether or not the consent of the driver of the manually driven vehicle 14 has been obtained, and another step may be provided to switch to autonomous driving in cases in which the consent of the driver of the manually driven vehicle 14 has been obtained.

In the guidance system of the fourth exemplary embodiment, at step S153 in the flowchart of FIG. 14, the proportion of the plural vehicles 12 traveling within the predetermined range in the surroundings of the manually driven vehicle 14 that are autonomously driven vehicles 15 is computed. However, the present disclosure is not limited thereto. Instead of the processing of step S153, the total proportion of the plural vehicles 12 traveling within the predetermined range in the surroundings of the manually driven vehicle 14 that are autonomously driven vehicles 15 or unoccupied remotely driven vehicles 19A may be computed.

In the guidance system 10 of the first to the fourth exemplary embodiments, the server device 18 acquires the travel states of the plural vehicles 12 traveling on the road 70 by communicating with the plural vehicles 12. However, the present disclosure is not limited thereto. For example, in addition to, or as an alternative to, communicating with the plural vehicles 12, plural detection devices may be provided along the road 70 such that the travel states of the plural vehicles 12 traveling on the road 70 are acquired through communication with the plural detection devices.

Note that the guidance processing executed by the CPUs 21, 41, and 51 reading software (for example programs) in the exemplary embodiments described above may be executed by various processors other than the CPUs. Examples of such processors include programmable logic devices (PLDs) such as field-programmable gate arrays (FPGAs) that have a circuit configuration that can be modified following manufacture, or dedicated electrical circuits, these being processors such as application specific integrated circuits (ASICs) that have a custom designed circuit configuration to execute specific processing. The guidance processing may be executed using one of these processors, or may be executed by a combination of two or more processors of the same type or different types to each other (for example a combination of plural FPGAs, or a combination of a CPU and an FPGA). A more specific example of a hardware structure of these various processors is electric circuitry combining circuit elements such as semiconductor elements.

The exemplary embodiments described above describe a format in which the guidance programs are stored (for example installed) in advance in the ROMs 22, 42, and 52 or in the storage 24, 44, and 54. However, there is no limitation thereto. The programs may be provided in a format recorded on a recording medium such as compact disc read only memory (CD-ROM), digital versatile disc read only memory (DVD-ROM), or universal serial bus (USB) memory. Alternatively, the programs may be configured in a format to be downloaded from an external device through a network.

The disclosure of Japanese Patent Application No. 2019-138983, filed on Jul. 29, 2019, is incorporated in its entirety by reference herein.

All cited documents, patent applications, and technical standards mentioned in the present specification are incorporated by reference in the present specification to the same extent as if each individual cited document, patent application, or technical standard was specifically and individually indicated to be incorporated by reference.

What is claimed is:

1. A guidance control device, comprising:
an acquisition section configured to acquire travel states of a plurality of vehicles traveling on a road;
a detection section configured to detect a situation in which, among the plurality of vehicles, a predetermined proportion or more are a plurality of autonomously driven vehicles traveling in a periphery of a manually driven vehicle; and
a guidance section configured to recommend remote driving or autonomous driving to a driver of the manually driven vehicle in a case in which the predetermined proportion or more of the plurality of autonomously driven vehicles traveling in the periphery of the manually driven vehicle are detected by the detection section.

2. The guidance control device of claim 1, wherein the detection section detects the proportion of the plurality of vehicles traveling within a predetermined range in the periphery of the manually driven vehicle that are the autonomously driven vehicles.

3. The guidance control device of claim 1, wherein the acquisition section acquires the travel states of the plurality of vehicles by communicating with the plurality of vehicles.

4. The guidance control device of claim 1, wherein a remote center, from which remote driving is performed, is notified of the existence of the manually driven vehicle when the guidance section recommends remote driving to the driver of the manually driven vehicle.

5. The guidance control device of claim 1, wherein:
the detection section is configured to detect a situation in which, among the plurality of vehicles, a predetermined proportion or more are manually driven vehicles traveling in a periphery of an autonomously driven vehicle; and
the guidance section is configured to recommend manual driving to the autonomously driven vehicle in a case in which the predetermined proportion or more of the manually driven vehicles traveling in a periphery of the autonomously driven vehicle are detected by the detection section.

6. The guidance control device of claim 1, wherein the autonomously driven vehicles comprise an unoccupied remotely driven vehicle.

7. A guidance system, comprising:
the guidance control device of claim 1;
a switchover control section configured to switch the manually driven vehicle to a remotely driven vehicle when remote driving has been recommended to the driver of the manually driven vehicle by the guidance section that recommends remote driving;
a remote center configured to transmit control information to perform remote driving at the remotely driven vehicle that has been switched to remote driving by the switchover control section; and
a remote driving control section provided at the remotely driven vehicle and configured to execute remote driving based on the control information received from the remote center.

8. The guidance system of claim 7, wherein the switchover control section is provided at the guidance control device.

9. The guidance system of claim 7, wherein the switchover control section does not switch the manually driven vehicle to a remotely driven vehicle in a case in which communication between the manually driven vehicle and the remote center is unstable.

10. The guidance system of claim 7, wherein the remote driving control section causes the remotely driven vehicle, which has been switched to remote driving by the switchover control section, to travel by remote driving so as to follow a mother car configured by any of the plurality of autonomously driven vehicles.

11. A guidance control program that is executable by a computer to perform processing, the processing comprising:
a step of acquiring travel states of a plurality of vehicles traveling on a road;
a step of detecting a situation in which, among the plurality of vehicles, a predetermined proportion or more are a plurality of autonomously driven vehicles traveling in a periphery of a manually driven vehicle; and
a step of recommending remote driving or autonomous driving to a driver of the manually driven vehicle in a case in which the predetermined proportion or more of the plurality of autonomously driven vehicles traveling in the periphery of the manually driven vehicle are detected.

12. A guidance control device, comprising:
memory; and
a processor coupled to the memory, the processor being configured to:
acquire travel states of a plurality of vehicles traveling on a road,
detect a situation in which, among the plurality of vehicles, a predetermined proportion or more are a plurality of autonomously driven vehicles traveling in a periphery of a manually driven vehicle; and
recommend remote driving or autonomous driving to a driver of the manually driven vehicle in a case in which the predetermined proportion or more of the plurality of autonomously driven vehicles traveling in the periphery of the manually driven vehicle are detected.
